(19) United States
(12) Patent Application Publication
(10) Pub. No.: US 2023/0245211 A1
(43) Pub. Date: Aug. 3, 2023

(54) DIGITAL LAYAWAY

(71) Applicant: NCR Corporation, Atlanta, GA (US)

(72) Inventors: Gina Torcivia Bennett, Lawrenceville, GA (US); Aleah Jean Kadry, Atlanta, GA (US); Kelli Lee, Atlanta, GA (US); Kip Oliver Morgan, Atlanta, GA (US)

(21) Appl. No.: 17/587,788

(22) Filed: Jan. 28, 2022

(51) Int. Cl. G06Q 30/06

(52) U.S. Cl. CPC G06Q 30/0633

(57) ABSTRACT

A virtual layaway service is provided. A user-facing interface to the service is accessed through a transaction interface associated with transaction terminals of a retailer or associated with mobile retail applications of the retailer provided on user-operated devices. The service flags transaction histories or records with items placed in layaway and payment progress made toward paying off the items using an existing transaction system and an existing loyalty system of the retailer. Customers can view payment progress, add new items to layaway, and make payments via the user-facing interface of the service. Angel donors also view the items designated for layaway and can make donations to specific items or all the items via the user-facing interface.

### BACKGROUND

Major retailers have been canceling layaway programs recently. These are popular programs with consumers who like to pay for products over time. There are a number of reasons why retailers have been getting rid of these programs.

For example, reserving and storing items for layaway is expensive, the layaway items take up valuable space that could be used for items actually being sold. This has become especially problematic during the COVID19 pandemic with the supply chain disruptions throughout the world economy. As of now, businesses are having trouble keeping shelves stocked with items, such that reserving and storing layaway items becomes even more costly to do for the businesses because items when stocked are being sold nearly immediately.

What layaway programs that still do exist have started charging the customers interest, which makes the cost of doing layaway more expensive to the very type of customer that can least afford the added expense. Businesses want the interest to reserve the item and store in their inventory during the layaway period in order to offset expenses associated with the item occupying valuable space and not being sold more quickly.

Additionally, many customers who utilize layaway programs do so because they are unable to obtain credit to qualify for loans or credit cards. Thus, layaway programs are the only mechanism these types of customers have to make purchases of expensive items.

### SUMMARY

In various embodiments, a system and methods for digital layaway techniques are presented.

According to an embodiment, a method for digital layaway techniques is provided. A workflow for virtual layaways is integrated into a transaction interface of a retailer. The workflow is processed when activated through the transaction interface by a user. Virtual layaway operations are performed as directed by the user while processing the workflow.

### BRIEF DESCRIPTION OF THE DRAWINGS

FIG. 1 is a diagram of a system for digital layaway techniques, according to an example embodiment.

FIG. 2 is a diagram of a method for digital layaway techniques, according to an example embodiment.

FIG. 3 is a diagram of another method for digital layaway techniques, according to an example embodiment.

### DETAILED DESCRIPTION

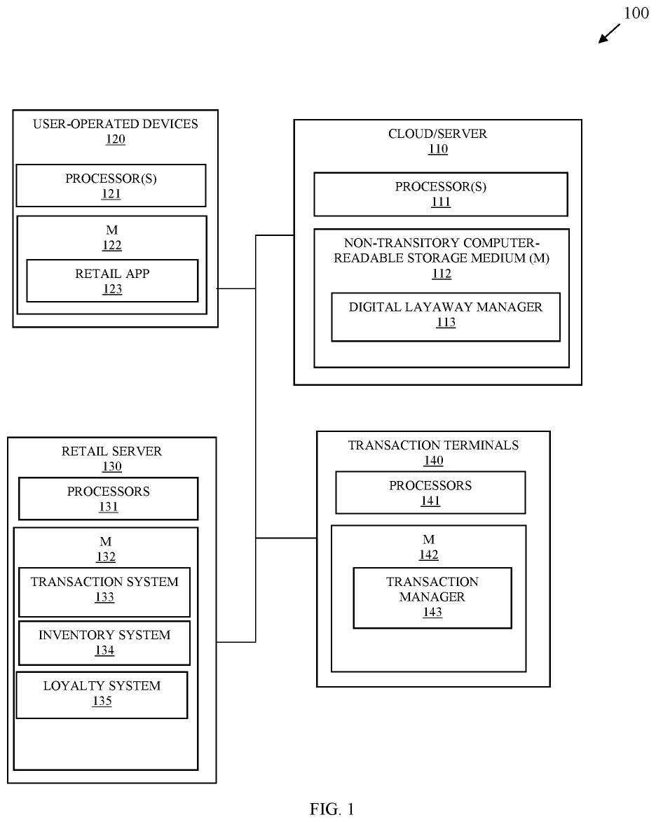

FIG. 1 is a diagram of a system/platform 100 for digital layaway techniques, according to an example embodiment. It is to be noted that the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of digital layaway techniques, presented herein and below.

System 100 provides a processing environment by which a customer can create a virtual layaway for a desired item of a store through an enhanced mobile application of the retailer or during checkout at a transaction terminal within the store. The retailer does not specifically set the item aside as being purchased nor is the item tracked as being a potentially sold item within the inventory of the retailer. The customer can view the status/progress of the layaway item via the mobile application or during any subsequent checkout. The customer can also make payments during a checkout for other items or through the mobile application. Angel donators may also access an alternative workflow during a checkout with the store to see the items placed in the virtual layaway and make payments on behalf of all, some, or a specific layaway item. Similarly, the Angel donators can use the mobile application of the retailer to view what is in layaway and make donations to all, some, or a specific layaway item. When a customer's layaway item is paid off, the customer may take the item home with them assuming the item is in stock within the store at the time the customer has paid off the item. When the item is no longer in stock at the store, the customer is given the option to take a substitute item of equal or lesser value associated with the original layaway item. The customer is provided an in-store credit or money when a substitute item is selected that had a lower value than the original layaway item.

A variety of embodiments are possible with the above discussed techniques and are described herein and below.

System/Platform 100 comprises a cloud/server 110, user-operated devices 120, a retail server 130, and transaction terminals 140.

Cloud/server 110 comprises at least one processor 111 and a non-transitory computer-readable storage medium 112. Medium 112 comprises executable instructions for a digital layaway manager 113. The executable instructions when provided to processor 111 from medium 112 cause the processor 111 to perform operations discussed herein and below with respect to 113.

User-operated device 120 comprises at least one processor 121 and a non-transitory computer-readable storage medium 122. Medium 122 comprises executable instructions for an enhanced retail mobile application (app) 123. The executable instructions when provided to processor 121 from medium 122 cause the processor 121 to perform operations discussed herein and below with respect to 123.

Retail server 130 comprises at least one processor 131 and a non-transitory computer-readable storage medium 132. Medium 132 comprises executable instructions for a transaction system 133, an inventory system 134, and a loyalty system 135. The executable instructions when provided to processor 131 from medium 132 cause the processor 131 to perform operations discussed herein and below with respect to 133-135.

Each transaction terminal 140 comprises at least one processor 141 and a non-transitory computer-readable storage medium 142. Medium 142 comprises executable instructions for a transaction manager 143. The executable instructions when provided to processor 141 from medium 142 cause the processor 141 to perform operations discussed herein and below with respect to 143.

Initially, the workflows associated with the transaction interface of transaction manager 143 and retail app 123 are enhanced to include a virtual digital layaway workflow that interacts with digital layaway manager 113. The main screens associated with the transaction interface are modified to include a layaway option, which when selected by a customer or an angel donator brings up a user-facing interface to digital layaway manager 113. The angel donators do not have to supply their identities and may operate the workflow associated with the digital layaway manager 113 anonymously if so desired. The customers are registered at least when a first item that is placed in the virtual layaway by the customers through the user-facing interface of digital layaway manager 113.

When a customer decides that an item is to be placed in virtual layaway, the item and customer can be identified in a number of different manners. The customer may operate retail app 123 within the store access the workflow associated with digital layaway manager 113 and scan an item barcode. Since the customer is already registered (registered when app 123 was downloaded and initiated by the customer on device 120) and part of the retailer's loyalty system 135, manager 135 can record the item in the existing transaction history on the loyalty account associated with the customer. Alternatively, the customer may take a picture of the item code or the item itself and go to a transaction terminal 140, access the workflow associated with manager 113 via the transaction interface of transaction manager 143 and enter the item code or the image of the item. The customer may also access search and browser features via the user-facing interface of manager 113 to identify the item, link the item to the customer, and place the item virtually into layaway with the store through manager 113. Still further, the customer may take the item to a customer support desk within the store where an assistance accesses the workflow associated with manager 113 from the transaction interface of transaction manager 143 and enters the customer's loyalty account number and item details for the item being virtually placed into layaway through interaction with manager 113. An unregistered customer is asked to register for a loyalty account via the user-facing interface of manager 113 when attempting to place an item in the virtual store layaway.

Manager 113 uses Application Programming Interfaces (APIs) to interact with the retailers transaction system 133, inventory system 134, and loyalty system 135. Transaction histories from loyalty system 135 can be accessed by manager 113 to identify each item that was placed in virtual layaway and has not yet been fully paid for or acquired by a customer. The histories provided each item and the existing outstanding balance along with how much has been paid to date and to which customer the corresponding item is associated with. Partial payments made toward an item in virtual layaway can be made by manager 113 through transaction system 133 and identified via a layaway transaction type. When an item is fully paid off, manager 113 can inspect a store's inventory for the item desired by the customer through inventory system 134. The retailer can determine at any given point in time what money is associated with layaways and the items associated with those layaways through the transaction histories (which include transaction types for the layaway transaction type). The retailer does not manage inventory based on what is currently pending in the layaway because the items are virtually in layaway and are not specifically set aside for paid off layaway items.

When a customer desires to make a payment on an item in the virtual layaway, the customer can access the transaction interface associated with app 123 or transaction manager 143 and provide a payment method and an amount to apply towards the layaway item. When the customer is at a transaction terminal 140 associated with a Self-Service Terminal (SST) 140 the customer may also provide payment via cash to the media infeed associated with the media depository of the SST 140. The customer may also use an attendant operated terminal 140, such as a Point-Of-Sale (POS) terminal 140 and provide payment through the attendant. The attendant access the workflow associated with manager 113 via the transaction interface of transaction manager 143 and provides the payment. Once payment is made, manager 113 initiates a layaway transaction type with transaction system 133 to record the amount provided for the layaway item and the customer identifier in a transaction record, which becomes part of the transaction history for the customer and part of the overall store transaction history for all customers of the store.

When the customer has fully paid off a layaway item, notice is sent to the customer by manager 113 (text message, email message, in-app message for app 123, or through the transaction interface of transaction manager 143). The customer may acquire the item from the store, use app 123 or the transaction interface of transaction manager 143 to scan the item code and a receipt is provided for the item electronically or printed at terminal 140. The customer may now leave the store with the item. The customer may also go to an attendant operated terminal 140 to have the item code scanned, receive the receipt, and exit the store with the item.

When the customer is notified that the item is paid off by manager 113, manager 113 may also check the store inventory through inventory system 134 to see if the item is still in stock at the store. When the item is no longer in stock at the store, manager 113 provides with the notification one or more substitute items that are in stock at the store and available if the customer so desires one of the substitute items. The substitute items are equal in value to what was paid to pay off the layaway item or are of a lesser value from what was paid to pay off the layaway item. If the paid off amount by the customer for the layaway item is greater than a price of a substitute item chosen by the customer to take home, then the transaction interface of app 123 or transaction manager 143 provides the customer with an in-store credit or an electronic voucher to obtain a cash refund at an SST 140 or a POS terminal 140.

Each time a customer interacts with the workflow associated with manager 113 via the app 123 of via terminal 140, the user-facing interface to manager 113 presents a number of options to the customer, such as view my current layaway items and current progress, make a payment on a layaway item, or add an item to layaway. The user-facing interface may graphically present a progress bar based on the needed price to purchase a layaway item and the current amount paid towards the needed price. The progress bar may be rendered under an image of the corresponding layaway item.

In addition to virtually maintaining layaway for a store and for customers of the store via the transaction system 133 and the loyalty system 135, system 100 provides techniques by which angel donators can pay off or pay down some, all, or specific layaway items via manager 113.

Angel donators can access manager 113 in the same manner that customers did, via the enhanced transaction interfaces of app 123 and transaction manager 143 that forks off a layaway workflow with manager 113. Customer names and identifiers may be blocked for anonymity of the customers, but the user-facing interface to manager 113 presents all the items in the store that are currently associated with virtual layaways along with how much has been paid and how much is still needed. Each unique item may be presented once (such as a red bike) and include a total number of the bike currently in layaway. When the angel donator clicks the image of the red bike, each individual red bike and its payment progress is presented to the angel donator. The angel donator can make a payment toward all items in layaway in which case manager 113 evenly distributes the amount provided by the angel donator across all items. Manager 113 initiates transactions of the layaway type with transaction system 133 to record the payments in the transaction history of the store. An angel donator may also select a specific item to pay or pay down, in which cases manager 113 initiates a single transaction of the layaway type with transaction system 133 to record the payment in a transaction history associated with the customer having that specific item in virtual layaway.

Any customer of the store can view all the virtual layaway items by accessing the workflow of manager 113 through the transaction interfaces associated with app 123 and transaction manager 143. This allows all customers to potentially become angel donators. The customer can make a single donation of any amount, and it can be evenly distributed to each of the layaway items of the store through manager 113. This makes the visibility of some customers need accessible to all customers of the store without identify the customers that are in need.

In an embodiment, app 123 and transaction manager 143 are existing modules managed by a retailer that have their transaction interfaces enhanced to fork off and process a new workflow for manager 113.

In an embodiment, manager 113 is subsumed and processed on retail server 120.

In an embodiment, transaction system 133, inventory system 134, and loyalty system 135 are subsumed, hosted, and processed on cloud 110.

In an embodiment, the transaction terminals 140 comprise SSTs, POS terminals, or customer-assistance terminals.

In an embodiment, device 120 is a mobile phone, a tablet, a wearable processing device, a laptop, or a desktop.

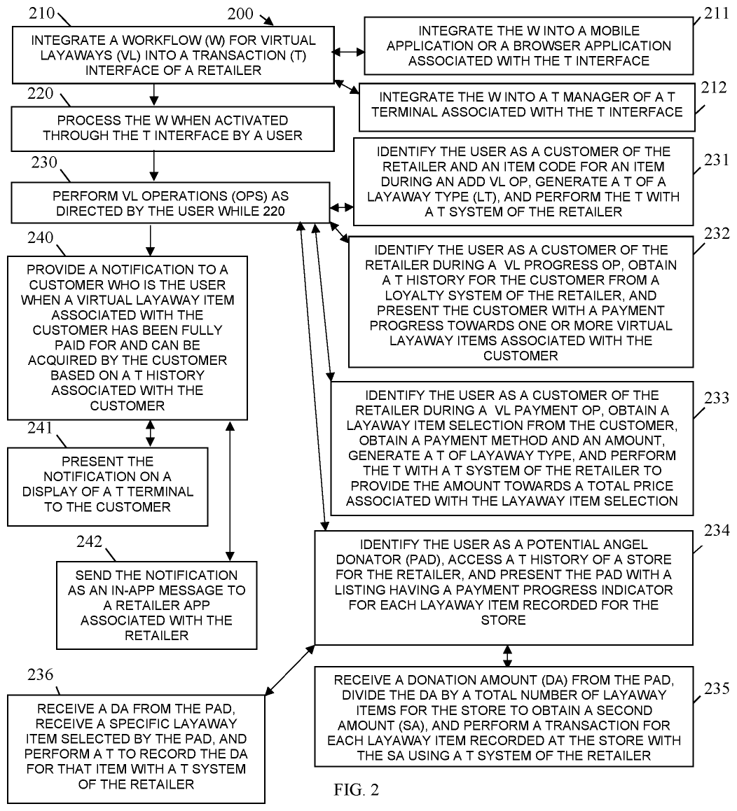

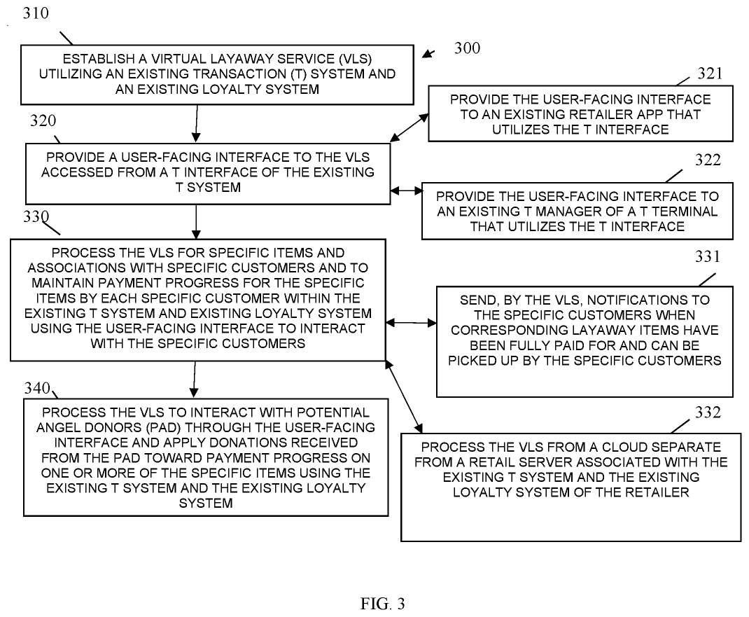

The above-referenced embodiments and other embodiments are now discussed within FIGS. 2-3.

FIG. 2 is a diagram of a method 200 for digital layaway techniques, according to an example embodiment. The software module(s) that implements the method 200 is referred to as a “layaway manager.” The layaway manager is implemented as executable instructions programmed and residing within memory and/or a non-transitory computer-readable (processor-readable) storage medium and executed by one or more processors of one or more devices. The processor(s) of the device that executes the layaway manager are specifically configured and programmed to process the layaway manager. The layaway manager may have access to one or more network connections during its processing. The network connections can be wired, wireless, or a combination of wired and wireless.

In an embodiment, the device that executes the layaway manager is a cloud 110. In an embodiment, the device that executes the layaway manager is server 110.

In an embodiment, layaway manager is all or some combination of 113, 123, and 143.

At 210, the layaway manager integrates a workflow for virtual layaways into a transaction interface of a retailer.

In an embodiment, at 211, the layaway manager integrates the workflow into a mobile application 123 or browser application associated with the transaction interface of the retailer.

In an embodiment, at 212, the layaway manager integrates the workflow into a transaction manager 143 or a transaction terminal 140 associated with the transaction interface of the retailer.

At 220, the layaway manager processes the workflow when activated through the transaction interface by a user.

At 230, the layaway manager performs virtual layaway operations as directed by the user during or while 230.

In an embodiment, at 231, the layaway manager identifies the user as a customer of the retailer and an item code for an item during an add virtual layaway operation. The layaway manager generates a transaction of a layaway type and performs the transaction with a transaction system 133 of the retailer.

In an embodiment, at 232, the layaway manager identifies the user as a customer of the retailer during a virtual layaway progress operation. The layaway manager obtains a transaction history for the customer from a loyalty system 135 of the retailer and presents the customer with a payment progress towards one or more virtual layaway items associated with the customer.

In an embodiment, at 233, the layaway manager identifies the user as a customer of the retailer during a virtual payment operation. The layaway manager obtains a layaway item selection from the customer, generates a transaction of a layaway type, and performs the transaction with a transaction system 133 of the retailer to provide the amount towards a total price associated with the layaway item selection.

In an embodiment, at 234, the layaway manager identifies the user as a potential angel donator. The layaway manager access a history of a store for the retailer and presents the potential angel donator with a listing having a payment progress indicator for each layaway item recorded for the store.

In an embodiment of 234 and at 235, the layaway manager receives a donation amount from the potential angel donator and divides the donation amount by a total number of layaway items for the store to obtain a second amount per layaway item. The layaway manager performs a transaction for each layaway item recorded at the store with the second amount using a transaction system 133 of the retailer.

In an embodiment of 234 and at 236, the layaway manager receives a donation amount from a potential angel donator and receives a specific layaway item selected by the potential angel donator. The layaway manager performs a transaction to record the donation amount for that specific item with a transaction system 133 of the retailer.

In an embodiment, at 240, the layaway manager provides a notification to a customer who is the user when a virtual layaway item associated with the customer has been fully paid for and can be acquired by the customer based on a transaction history associated with the customer.

In an embodiment of 240 and at 241, the layaway manager presents the notification on a display of a transaction terminal 140 to the customer.

In an embodiment of 240 and at 242, the layaway manager sends the notification as an in-app message to a retailer application (app) 123 associated with the retailer.

FIG. 3 is a diagram of another method 300 for digital layaway techniques, according to an example embodiment. The software module(s) that implements the method 300 is referred to as a “cloud-based virtual layaway manager.” The cloud-based virtual layaway manager is implemented as executable instructions programmed and residing within memory and/or a non-transitory computer-readable (processor-readable) storage medium and executed by one or more processors of a device. The processors that execute the cloud-based virtual layaway manager are specifically configured and programmed for processing the cloud-based virtual layaway manager. The cloud-based virtual layaway manager may have access to one or more network connections during its processing. The network connections can be wired, wireless, or a combination of wired and wireless.

In an embodiment, the device that executes the cloud-based virtual layaway manager is cloud 110.

In an embodiment, the cloud-based virtual layaway manager is some combination or all of 113 and/or method 200.

The cloud-based virtual layaway manager presents another and, in some ways, an enhanced processing perspective from that which was shown above for system/platform 100 and/or method 200.

At 310, the cloud-based virtual layaway manager establishes a virtual layaway service utilizing an existing transaction system 133 and an existing loyalty system 135 of a retailer.

At 320, the cloud-based virtual layaway manager provides a user-facing interface to the virtual layaway service accessed from a transaction interface of the existing transaction system 133.

In an embodiment, at 321, the cloud-based virtual layaway manager provides the user-facing interface to an existing retailer app 123 that utilizes the transaction interface.

In an embodiment, at 322, the cloud-based virtual layaway manager provides the user-facing interface to an existing transaction manager 143 of a transaction terminal 140 that utilizes the transaction interface.

At 330, the cloud-based virtual layaway manager processes the virtual layaway service for specific items and associations with specific customers and to maintain payment process for specific items by each specific customer within the existing transaction system 133 and the existing loyalty system 135 using the user-facing interface to interact with the specific customers.

In an embodiment, at 331, the virtual layaway service sends notifications to the specific customers when corresponding layaway items have been fully paid for and can be picked up by the specific customers.

In an embodiment, at 332, the cloud-based virtual layaway manager process the virtual layaway service from a cloud 110 that is separate from a retail server 130 associated with the existing transaction system 133 and the existing loyalty system 135 of the retailer.

In an embodiment, at 340, the cloud-based virtual layaway manager processes the virtual layaway service to interact with potential angel donors through the user-facing interface and applies donations received from the potential angel donors toward payment progress on one or more of the specific items using the existing transaction system 133 and the existing loyalty system 135.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
integrating a workflow for virtual layaways into a transaction interface of a retailer;
processing the workflow when activated through the transaction interface by a user; and
performing virtual layaway operations as directed by the user while processing the workflow.

2. The method of claim 1, wherein integrating further includes integrating the workflow into a mobile application or a browser application associated with the transaction interface.

3. The method of claim 1, wherein integrating further includes integrating the workflow into a transaction manager of a transaction terminal associated with the transaction interface.

4. The method of claim 1, wherein performing further includes identifying the user as a customer of the retailer and an item code for an item during an add virtual layaway operation, generating a transaction of a layaway type, and performing a transaction with a transaction system of the retailer.

5. The method of claim 1, wherein performing further includes identifying the user as a customer of the retailer during a virtual layaway progress operation, obtaining a transaction history for the customer from a loyalty system of the retailer, and presenting the customer with a payment progress towards one or more virtual layaway items associated with the customer.

6. The method of claim 1, wherein performing further includes identifying the user as a customer of the retailer during a virtual layaway payment operation, obtaining a layaway item selection from the customer, obtaining a payment method from the customer and an amount, generating a transaction of layaway type, and performing the transaction with a transaction system of the retailer to provide the amount towards a total price associated with the layaway item selection.

7. The method of claim 1, wherein performing further includes identifying the user as a potential angel donator, accessing a transaction history of a store for the retailer, and presenting the potential angel donator with a listing having a payment progress indicator for each layaway item recorded for the store.

8. The method of claim 7 further comprising, receiving a donation amount from the potential angel donator, dividing the amount by a total number of layaway items for the store to obtain a second amount, and performing a transaction for each layaway item recorded at the store with the second amount using a transaction system of the store.

9. The method of claim 7 further comprising, receiving a donation amount from the potential angel donator, receiving a specific layaway item selected by the potential angel donator, and performing a transaction to record the donation amount for the specific layaway item with a transaction system of the retailer.

10. The method of claim 1 further comprising, providing a notification to a customer who is the user when a virtual layaway item has been fully paid for and can be acquired by the customer based on a transaction history associated with the customer.

11. The method of claim 10, wherein providing further includes present the notification on a display of a transaction terminal to the customer.

12. The method of claim 10, wherein providing further includes send the notification as an in-app message to a retailer application associated with the retailer.

13. A method, comprising:
establishing a virtual layaway service utilizing an existing transaction system and an existing loyalty system of a retailer;
providing a user-facing interface to the virtual layaway service accessed from a transaction interface of the existing transaction system; and
processing the virtual layaway service to flag item codes for specific items and associations with specific customers and to maintain payment progress for the specific items by each specific customer within the existing transaction system and existing loyalty system using the user-facing interface to interact with the specific customers.

14. The method of claim 13 further comprising, processing the virtual layaway service to interact with potential angel donors through the user-facing interface and apply donations received from the potential angel donors toward payment progress on one or more of the specific items using the existing transaction system and the existing loyalty system.

15. The method of claim 13, wherein providing further includes providing the user-facing interface to an existing retailer application that utilizes the transaction interface.

16. The method of claim 13, wherein providing further includes providing the user-facing interface to an existing transaction manager of a transaction terminal that utilizes the transaction interface.

17. The method of claim 13, wherein processing further includes sending, by the virtual layaway service notifications to the specific customers when corresponding layaway items have been fully paid for and can be picked up by the specific customers.

18. The method of claim 13, wherein processing further includes processing the virtual layaway service from a cloud separate from a retail server associated with the existing transaction system and the existing loyalty system.

19. A system, comprising:
at least one server;
transaction terminals; and
user-operated devices;
wherein the at least one server is configured to:
provide a user-facing interface to a virtual layaway service accessed from a first transaction interface of a retailer on the transaction terminals;
provide the user-facing interface to the virtual layaway service access from a second transaction interface of the retailer on the user-operated devices;
maintain in transaction histories of the retailer items designated for layaway without reserving or setting aside any inventory space for the items based on interactions with customers of the retailer through the user-facing interface;
permit potential angel donors to view payment progress on the items and provide donations for the items through the user-facing interface; and
notify the customers when a specific item has been paid in full indicating that the customers are free to take the item from a store of the retailer.

20. The system of claim 19, wherein the transaction terminals comprise Point-Of-Sale (POS) terminals operated by attendants of the retailer and Self-Service Terminals (SSTs) operated by the customers and the potential angel donors.
